(19) United States
(12) Patent Application Publication
(10) Pub. No.: US 2009/0159544 A1
(43) Pub. Date: Jun. 25, 2009

(54) MEDICINE BOTTLE WITH GRIP

(75) Inventor: Michael P. Tune, Arlington, TN (US)

Correspondence Address: SCHERING-PLOUGH CORPORATION;PATENT DEPARTMENT (K-6-1, 1990), 2000 GALLOPING HILL ROAD, KENILWORTH, NJ, 07033-0530, US

(73) Assignee: Schering-Plough Healthcare Products, Inc.

(21) Appl. No.: 11/960,159

(22) Filed: Dec. 19, 2007

(51) Int. Cl. A61J 1/03; B65D 50/04; A47F 5/08

(52) U.S. Cl. 211/153; 215/201; 206/528; 215/203; 215/209; 206/570

(57) ABSTRACT

A bottle for a medicine is disclosed. The bottle may have a base portions a threaded neck portion, a child resistant cap and a grip portion. The bottle may be part of a kit having other bottles without a grip section. The bottle may be part of a retail display system.

### BACKGROUND

Medication bottles may be closed with a threaded cap that is removed by a user applying a twisting force to the cap with one hand while gripping the body of the bottle with the other hand. Bottles having a large diameter may be difficult to open because the large diameter body portion may impede gripping by the user's hand. This difficulty may be heightened in individuals having a disability, such as, e.g., arthritis, particularly for child-resistant bottle closures.

### BRIEF DESCRIPTION OF DRAWINGS

FIG. 1 depicts a third angle perspective view of an example set of bottles without caps, according to an example embodiment of the present invention.

FIG. 2 depicts a front view of the example set of bottles of FIG. 1 with caps.

FIG. 3 depicts a cross-sectional view of a bottle of FIG. 2.

FIGS. 4a and 4b depict a child-resistant closure mechanism of the cap of the bottle of FIG. 3.

FIG. 5 depicts a front view of the example set of bottles of FIG. 1, in a closed position and in a retail display system, according to an example embodiment of the present invention.

### DETAILED DESCRIPTION OF EXAMPLE EMBODIMENTS

Medicine bottles up to a certain size have diameters that may be gripped easily by one hand so that the other hand is free to remove the cap. Larger-sized bottles typically have larger diameters to accommodate larger internal volumes. There may be advantages to increasing the diameter of larger-sized bottles, such as, e.g., providing a lower center of gravity and increasing the bottom surface area relative to the height, thereby making it more difficult for the bottle to be accidentally tipped over when resting on its base. A potential disadvantage is that the larger-diameter base may be more difficult to grasp with one hand. This can make opening and closing the bottle substantially more difficult, especially where the bottle has a child resistant cap that may require forces to applied other than simply turning the cap. Some child resistant caps, for example, require applying a substantial downward force while turning the cap. This additional applied force may make gripping the base of the bottle especially difficult. Thus, a problem exists where both a large diameter and good gripability are desired.

Example embodiments of the present invention address at least the aforementioned problem by providing a grip portion of reduced diameter between the large-diameter base portion and the top portion of the bottle where the cap is secured. In this manner, the bottle is provided with a large internal capacity, yet is easy to grip with one hand at the smaller-diameter grip portion, leaving the second hand free to disengage the cap. The grip portion may allow the bottle to be gripped easily and sufficiently to fully support the bottle against both rotational forces and linear forces, such as, e.g., the downward force necessary to open and close some child resistant bottles. Accordingly, an ergonomic bottle is provided that allows for a large-diameter base.

According to some example embodiments of the present invention, some example bottles may be bottles for a powder or liquid having a substantially cylindrical base portion having a main diameter greater than about 8; a threaded neck portion having a neck diameter of about 4 centimeters; a child resistant cap fitted to the threaded neck portion and configured to provide a dosage measurement for the medicine, the cap having a cap diameter of about 5 centimeters; a grip portion integrally formed with the bottle and disposed between the base portion and the neck portion, the grip portion having a grip diameter that is substantially less than the main diameter and substantially greater than the cap diameter, where the grip diameter is greater than approximately 7 centimeters and less than approximately 8 centimeters. Some examples may have an undercut portion disposed between the grip portion and the base portion, where the undercut portion has an undercut diameter that is less than the grip diameter. The bottle may contain a powder or liquid form of a medicine, for example a laxative, such as polyethylene glycol or similar product. In certain embodiments, the height of the bottle may be less than about 18 centimeters.

Some example bottles, according to some example embodiments of the present invention, may be bottles for a medicine having: a base portion having a main diameter; a threaded neck portion having a neck diameter, the neck diameter being substantially smaller than the main diameter. Some examples may have a child resistant cap fitted to the threaded neck portion and having a cap diameter. Some examples may have a grip portion disposed between the base portion and the neck portion, where the grip portion has a grip diameter that is substantially smaller than the main diameter and substantially greater than the neck diameter. Some caps may have an indicator that corresponds to a dose size. In some examples, the cap may have an internal volume that corresponds to a dose size. Some examples may have an undercut portion disposed between the grip portion and the base portion, where the undercut portion has an undercut diameter that is less than the grip diameter. In some examples, the medicine may be a laxative in powder form. The neck diameter may be greater than 2.5 centimeters. In some examples, the neck diameter may be about 3.8 centimeters. In some examples, the grip portion may be integrally formed with the bottle. In some examples, the grip diameter may be greater than 7 centimeters and less than 8 centimeters. In some examples, the main diameter may be greater than about 7.5 centimeters. In some examples, the main diameter may be greater than about 12 centimeters. In some examples, the main diameter is substantially constant along a majority of the base portion. In some examples, the height of the bottle may be less than about 17 centimeters. In some examples, the height of the bottle may be less than about 30 centimeters. In some examples, removal of the child resistant cap may require the application of an axially downward force while simultaneously rotating the cap with respect to the base portion.

According to some example embodiments of the present invention, some example methods of providing a medicine to a retailer may include delivering the medicine to the retailer in a first type of bottle and delivering the medicine to the retailer in a second type of bottle, where the second type is larger volume than the first type, and where the second type of bottle is a bottle in accordance with the examples set forth above. In some examples, the bottles of the two types are delivered in the same shipment. In some examples, the first type of bottle and the second type of bottle have caps of the same cap type.

According to some example embodiments of the present invention, some example delivery systems for a medication may include: a first type bottle containing the medicine; a second type bottle containing the medicine, where the second type bottle is a bottle as described above and being larger volume than the first type bottle, and where the first type bottle and second type bottle have lids configured to provide a dosage measurement for the medicine; and a unifying container holding the first type bottle and the second type bottle. In some examples, the lids of the first type bottle and the second type bottle may measure the same dosage. In some examples, the lids of the first type bottle and the second type bottle may be identical.

According to some example embodiments of the present invention, some example retail display systems for a medicine may include a retail display device, a first type bottle containing the medicine and located on the retail display device, and a second type bottle containing the medicine and located on the retail display device, where the second type bottle is a bottle as described above and is larger volume than the first type bottle. In some examples, the retail display system is a shelf.

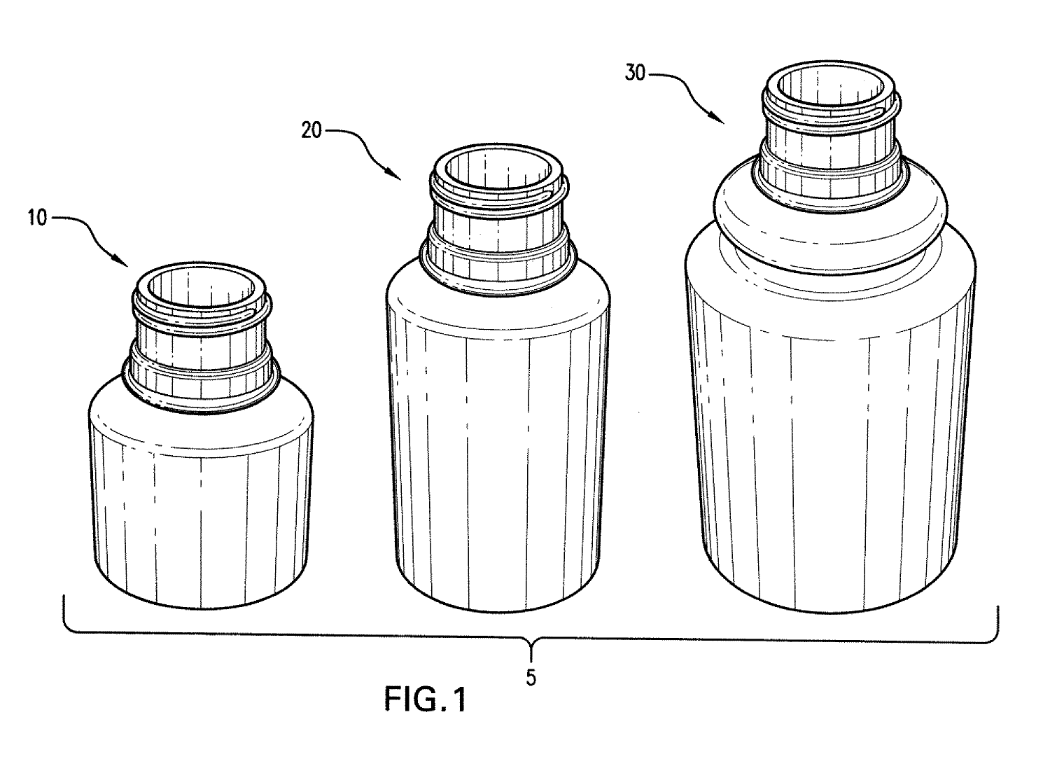

FIG. 1 depicts a third angle perspective view of an example set 5 of bottles 10, 20, 30 without caps according to an example embodiment of the present invention.

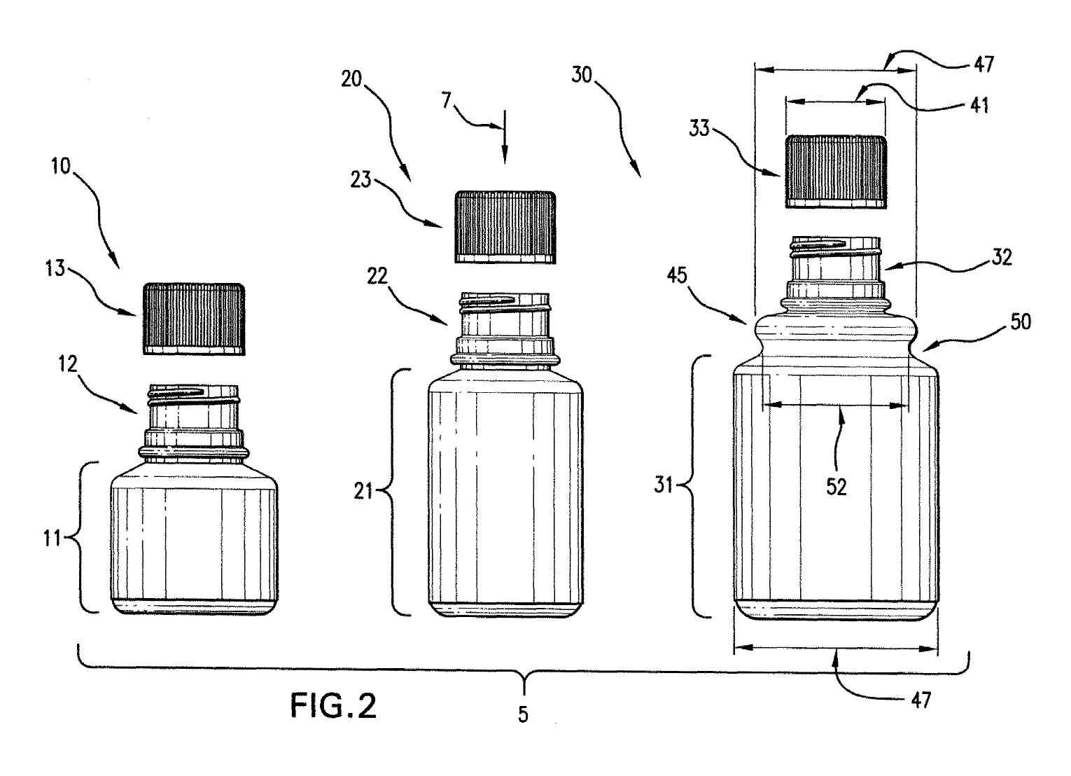

FIG. 2 depicts a front view of the example set 5 of bottles 10, 20, 30 of FIG. 1. Each bottle 10, 20, 30 has a cylindrical base portion 11, 21, 31, a threaded neck portion 12, 22, 32, and a child resistant cap 13, 23, 33 that is fitted to the threaded neck portion 12, 22, 32. Each cap 13, 23, 33 has a cap outer diameter 41 of about 5 centimeters. Each threaded neck portion 12, 22, 32 has an outer diameter of about 4 centimeters. The width of the threaded neck portion 12, 22, 32 may allow for a wide opening that may facilitate the dispensing of a medication, e.g., a laxative, in powder form. The size of the cap allows the cap to have an internal volume sufficiently sized to provide a vehicle for dosage measurement. For example, the total interior volume of the cap could correspond to a dosage size and/or a line or marking could correspond to a dosage when the cap is filled to the line or marking. Each of the three caps 13, 23, 33 depicted in FIG. 2 is identical with respect to each other and may be interchangeably fitted with any of the three different bottles 10, 20, 30. In this regard, all of the bottles 10, 20, 30 may contain different amounts of the same medicine, e.g. laxative, in powdered form, while having identical caps providing the same dosage measurement. When the cap 13, 23, 33 is attached to the threaded neck portion 12, 22, 32, each bottle 10, 20, 30 may be opened by disengaging the threaded interface between the threaded neck portion 12, 22, 32. This is accomplished by applying a twisting force between the cap 13, 23, 33 and the threaded neck portion 12, 22, 32. Because of the child proof construction of the cap 13, 23, 33, a substantial force must be simultaneously applied in an axially downward direction 7 in order for the twisting force to be transferred to the interface between an inner surface of the cap 13, 23, 33 and an outer surface of the threaded neck portion 12, 22, 32. Otherwise, an outer portion of the cap 13, 23, 33 spins with respect to an inner portion (including the inner surface) of the cap 13, 23, 33, while the inner portion remains stationary (and engaged) with respect to the threaded neck portion 12, 22, 32. The height of the larger-capacity bottle 30, not including the cap 33, may be less than 18 centimeters.

A user may open either of the two smaller-capacity bottles 10, 20 by gripping the cap 13, 23 with one hand and gripping the base portion 11, 21 with the other hand, and applying a twisting force (and simultaneous axially downward force) between the cap 13, 23 and the base portion 11, 21, which is integrally formed with the threaded neck portion 12, 22, from, e.g., plastic. The larger-capacity bottle 30 may be more difficult to grasp at the base portion 31 because the base portion 31 of the bottle 30 has a base portion diameter 40 that is greater than the diameter of each of the other bottles 10, 20. This may present particular difficulty to users with muscle, nerve, and/or joint afflictions such as, e.g., arthritis. Thus, in order to improve the gripability, a grip portion 45 is integrally formed with the bottle and disposed between the base portion 31 and the threaded neck portion 32. The grip portion 45 has a diameter 47 that is substantially less than the main diameter 40 and substantially greater than the cap diameter 41. In this regard, it should be appreciated that the grip portion is small enough for a large number of users can comfortable grip it with one hand, but large enough to provide some clearance between the cap and the hand gripping the grip portion, for example between about 7 and about 8 centimeters. An undercut portion 50, having a diameter 52 that is less than the grip portion diameter 47, is disposed between the grip portion 45 and the base portion 31. In the bottle 30 depicted in FIG. 2, the grip portion 45 ends and the undercut portion 50 begins at a point where the outer profile of the bottle transitions from convex to concave. It should be appreciated, however, that the undercut portion and the grip portion may be separated by a non-continuous profile (e.g., a sharp angle). The undercut portion 50 may provide better grip and allow the user to more easily support the weight of the bottle 30 when gripping around the grip portion 45. The undercut portion may also allow the base to be better supported when pressing the cap axially downward to overcome the child-resistant closure. Although the grip portion depicted in FIG. 2 has a curved profile, it should be appreciated that the grip portion may have other profiles, e.g., a flat vertical surface.

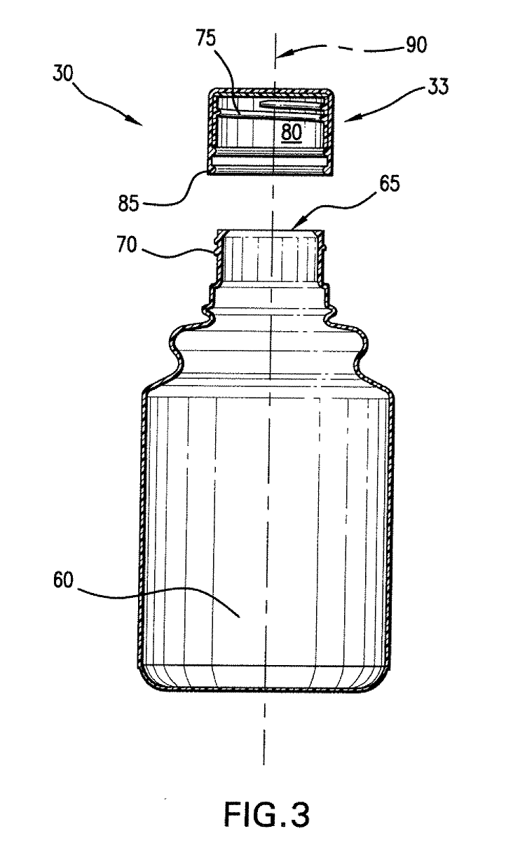

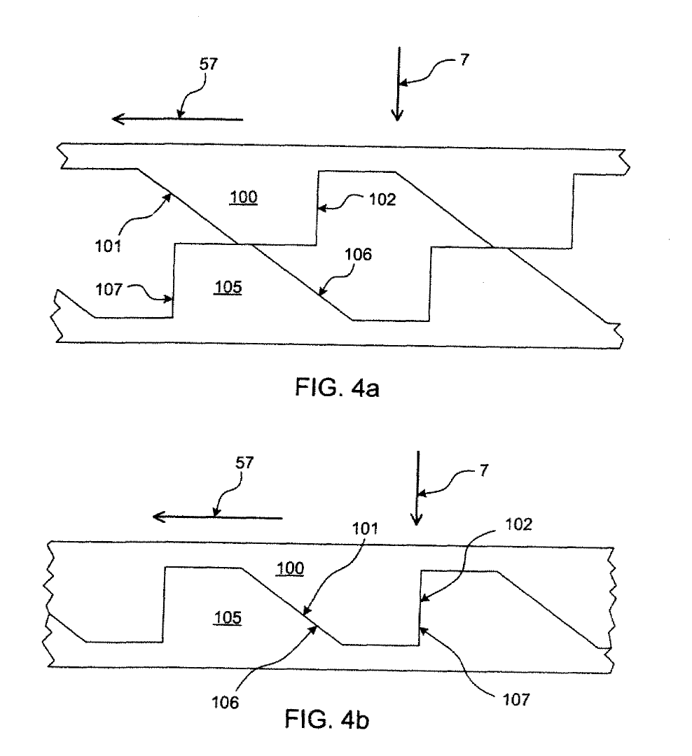

FIG. 3 depicts a cross-sectional view of the bottle 30 of FIG. 2. The bottle 30 has an internal cavity 60 that may hold, e.g., a laxative in powder form that may be dispensed through opening 65, by, e.g., pouring. The threaded neck portion 32 has external threads 70 that mate with internal threads 75 of an inner portion 80 of the cap 33. The inner portion 80 is constrained within an outer portion 85. The inner portion 80 may rotate within the outer portion 85 about an axis 90. There is also a small amount of axial clearance, allowing an amount of axial displacement between the inner portion 80 and the outer portion 85 along the axis 90. Referring to FIGS. 4a and 4b, along a periphery of the cap 33 are mating elements 100, 105. In the absence of a substantial force applied in the axially downward direction 7, when the cap is turned in a direction, e.g., counter-clockwise, to be opened, the angled surfaces 101, 106 guide the mating element 100 (which is fixed to and integral with the outer portion 85) past the mating element 105 (which is fixed to and integral with the inner portion 80 and fictionally coupled to the threaded neck portion 32 via the threaded interface there between) in a direction 57, as shown in FIG. 4A. Referring to FIG. 4b, in the presence of a substantial force in applied in the axially downward direction 7, the mating elements are pressed together such that the angled surfaces 101, 106 are unable to slide relative to each other. As such, tangential forces along direction 57 (and torque generated thereby) may be transferred between the mating elements 100, 105, and therefore between the inner portion 80 and the outer portion 85 of the cap 33. It is noted that when rotating the cap in the opposite direction (to close the cap) a minimal amount of downward force is required because surfaces 102 and 107 engage and are perpendicular to the plane of applied force. In other words, because the surfaces 102, 107 are not angled, they do not urge the mating elements 100, 105 axially away from each other. It should be appreciated in this regard that alternative or additional child-resistant closure mechanisms may be employed.

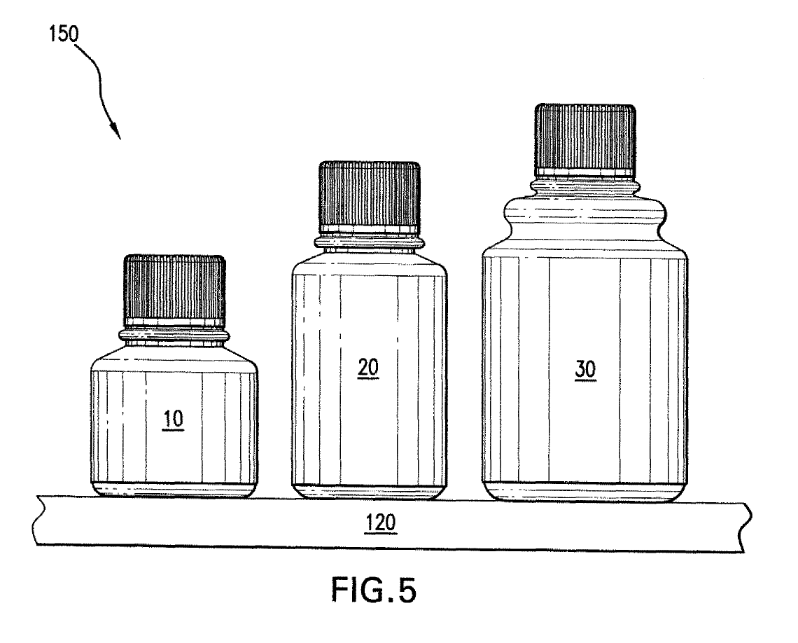

FIG. 5 depicts a front view of the example set of bottles of FIG. 1, in a closed position and as part of a retail display system 150, according to an example embodiment of the present invention. The retail display system includes a retail display device 120, in this case a shelf. Bottles 10, 20 of a first type have lower capacity and smaller base diameters than a second type of bottle 30. The bottles 10, 20 of the first type do not have a grip section, while the bottle 30 of the second type does. It is noted that the base diameters of the bottles 10, 20 of the first type are approximately the same as the diameter of the grip portion of the bottle 30 of the second type. The bottles 10, 20, 30 contain the same medicine, e.g. a laxative in powder form. Although the retail display system has the bottles increasing in size from left to right, it should be appreciated that the bottles may be displayed in any order, or on different shelves or racks. It should also be appreciated that although FIG. 5 shows two sizes of bottles of a first type and one size of bottle of a second type, any number (including one) of sizes of each type may be employed.

Several embodiments of the present invention are specifically described herein. However, it will be appreciated that modifications and variations of the present invention are covered by the above teachings and within the purview of the appended claims without departing from the spirit and intended scope of the invention.

What is claimed is:

1. A combination, comprising:
a bottle having
a cylindrical base portion having a main diameter greater than about 8;
a threaded neck portion having a neck diameter of about 4 centimeters;
a child-proof cap fitted to the threaded neck portion, e cap having a cap outer diameter of about 5 centimeters;
the height of the bottle is less than about 18 centimeters;
a grip portion integrally formed with the bottle and disposed between the base portion and the neck portion, the grip portion having a grip diameter that is substantially less than the main diameter and substantially greater than the cap outer diameter, the grip diameter being greater than about 7 and less than about 8; and
an undercut portion disposed between the grip portion and the base portion, the undercut portion having an undercut diameter that is less than the grip diameter; and
a powder contained in the bottle,
wherein and the cap is configured to provide a dosage measurement for the powder.

2. The combination of claim 1, wherein the powder is a medicine.

3. The combination of claim 1, wherein the powder is a laxative.

4. The combination of claim 1, wherein the powder is polyethylene glycol.

5. A bottle for a medicine, comprising:
a base portion having a main diameter;
a threaded neck portion having a neck diameter, the neck diameter being smaller than the main diameter;
a child-proof cap fitted to the threaded neck portion and configured to provide a dosage measurement for the medicine, the cap having a cap diameter; and
a grip portion disposed between the base portion and the neck portion, the grip portion having a grip diameter that is substantially smaller than the main diameter and substantially greater than the neck diameter.

6. The bottle of claim 5, wherein the cap has an indicator that corresponds to a dosage size.

7. The bottle of claim 5, wherein the cap has an internal volume that corresponds to a dose size.

8. The bottle of claim 5 further comprising an undercut portion disposed between the grip portion and the base portion, the undercut portion having an undercut diameter that is less than the grip diameter.

9. The bottle of claim 5, wherein the medicine is a laxative in powder form.

10. The bottle of claim 5, wherein the neck diameter is greater than 2.5 centimeters.

11. The bottle of claim 10, wherein the neck diameter is about 3.8 centimeters.

12. The bottle of claim 5, wherein the grip portion is integrally formed with the bottle.

13. The bottle of claim 5, wherein the grip diameter is greater than about 7 centimeters and less than about 8 centimeters.

14. The bottle of claim 10, wherein the main diameter is greater than about 7.5 centimeters.

15. The bottle of claim 10, wherein the main diameter is about 12 centimeters.

16. The bottle of claim 14, wherein the main diameter is substantially constant along a majority of the base portion.

17. The bottle of claim 16, wherein the height of the bottle is less than about 17 centimeters.

18. The bottle of claim 16, wherein the height of the bottle is less than about 30 centimeters.

19. The bottle of claim 5, wherein removal of the child resistant cap requires the application of an axially downward force while simultaneously rotating the cap with respect to the base portion.

20. The bottle of claim 5, further comprising:
means for measuring a dosage of the medicine formed as part of the means for closing.

21. A bottle for a medicine, comprising:
child resistant means for containing a medicine;
means for opening and closing the means for containing the medicine; and
means for enhancing the manual gripability of the means for containing the medicine by providing a portion that is narrower than a portion of the means for containing the medicine.

22. A method of providing a medicine to a retailer:
delivering the medicine to the retailer in a first type of bottle; and
delivering the medicine to the retailer in a second type of bottle, the second type of bottle being a larger volume than the first type of bottle, the second type of bottle being a bottle of claim 5.

23. The method of claim 22, wherein the bottles of the two types are delivered in the same shipment.

24. The method of claim 22, wherein the first type of bottle and the second type of bottle have caps of the same cap type.

25. A delivery system for a medicine, comprising:
a first type bottle containing the medicine,
a second type bottle containing the medicine, the second type bottle being a bottle of claim 5 and being larger volume than the first type bottle, the first type bottle and second type bottle having lids configured to provide a dosage measurement for the medicine; and
a unifying container holding the first type bottle and the second type bottle.

26. The delivery system of 25, wherein the lids of the first type bottle and the second type bottle measure the same dosage.

27. The deliver system of 26, wherein the lids of the first type bottle and the second type bottle are identical.

28. A retail display system for a medicine, comprising:
a retail display device:
a first type bottle containing the medicine and located on the retail display device;
a second type bottle containing the medicine and located on the retail display device, the second type bottle being a bottle of claim 5 and having a larger volume than and the same cap design as the first type bottle.

29. The retail display system of claim 28, wherein the retail display device is a shelf.
